(19) United States
(12) Patent Application Publication
(10) Pub. No.: US 2003/0198822 A1
(43) Pub. Date: Oct. 23, 2003

(54) Leather assembly and method of fabricating a leather assembly

(76) Inventor: Phillipp Schaefer, Hannover (DE)

Correspondence Address: LERNER AND GREENBERG, P.A., POST OFFICE BOX 2480, HOLLYWOOD, FL, 33022-2480, US

(21) Appl. No.: 10/419,595

(22) Filed: Apr. 21, 2003

(30) Foreign Application Priority Data
Apr. 19, 2002 (AT) GM256/2002
Jul. 16, 2002 (AT) GM 473/2002

(51) Int. Cl. B32B 9/02

(52) U.S. Cl. 428/473

(57) ABSTRACT

A leather assembly has a leather substrate with a leather surface with a grain structure forming a visible side of the leather assembly or which carries a dressing that forms the visible side. The dressing is preferably provided with a grain structure. A foam finish is formed on the flesh side of the leather substrate. The foam finish is a solidified plastics material containing hollow microspheres and is has a surface formed with a structural design. The foam finish is produced by applying a liquid plastics dispersion or solution to the flesh side and allowing the liquid to at least partly solidify. Heat and/or pressure applied to the foam finish then forms the structural design.

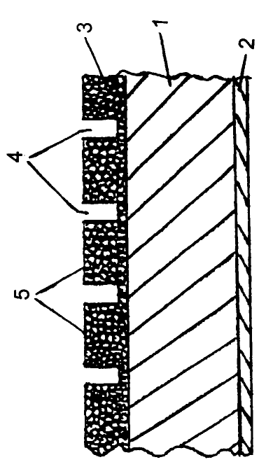

### BACKGROUND OF THE INVENTION

### FIELD OF THE INVENTION

The invention relates to a leather which has, on its surface, a grain structure forming the visible side or a dressing forming the visible side, which preferably has a grain structure. On its flesh side opposite the visible side surface, the leather has a foam finish consisting of a solidified plastics material containing hollow microspheres. The invention furthermore relates to a process for the production of such a leather.

It has become known that split leathers (splits), in particular, can be provided with a dressing on the visible side in order to impart a more attractive appearance to the visible side. Here, dressing consists of at least two layers, and at least one layer may contain hollow microspheres. The outer layer forming the visible side is first produced separately on a substrate and then bonded via the inner layer to the grain side of the split leather. At least the outer layer must meet the requirements set for the grain side of a leather and in particular must be hard and abrasion-resistant, must have good endurance and must be water-repellent and therefore has no soft foam structure.

It has also already been proposed to provide the grain side of a leather with a dressing which has hollow microspheres which are opened by buffing the surface, resulting in a suede effect. Owing to the opened hollow microspheres. Such a dressing does not have a foam structure.

It is also already known that hollow microspheres can be produced in a dressing by mixing compact particles with the liquid plastics material forming the dressing, from which particles the hollow microspheres are subsequently formed by the action of heat.

In particular, thin leathers, such as, for example, thin napa leathers, as used in the production of shoes, of the interior trim of cars and also for upholstered furniture, luggage, bags or the like, do not have sufficient cushioning properties, owing to their small thickness. Moreover, for use in vehicles, as shoe material and as luggage, preferred leathers are those which have a soft touch in combination with low weight per unit area, which is not present in the case of thin leathers. It is therefore known that separately prepared film-like foam materials which are bonded to the flesh side by adhesive bonding can be provided on the flesh side of these leathers which is opposite the visible side. Such a procedure is labor-intensive and expensive and gives rise to a large amount of waste since the film-like foam materials have to be cut to size according to the size of the leather. However, a substantial disadvantage of this procedure is that this foam sheet consisting of a film-like material and laminated with the flesh side of the leather easily becomes detached or splits since the internal strength of this foam material is low. Furthermore, deformation of such a leather, as is required in the production of shoes and of interior trims of cars, such as interior door claddings, central consoles, steering wheels and the like, causes uncontrollable, undesired movements of such a lamination, with the result that troublesome displacements and creases form.

In order to achieve the required cushioning properties, the laminated foam material must have a thickness of more than 1 mm. Even under low pressures, such a foam material reduces its volume and thus loses its cushioning effect.

I have previously proposed to produce a foam finish on the flesh side of a leather which is opposite the visible side by applying a liquid plastics material and subsequently solidifying the material by removal of liquid. The foam finish imparts the desired cushioning properties and a very soft touch to the leather even at small thickness and low density and is firmly bonded to the leather. Here, the foam finish consists of a solidified plastics dispersion and, in order to ensure the required air and water vapor permeability, contains both closed cells formed by hollow microspheres and small open cells arranged in the voids between the hollow microspheres. The hollow microspheres may also be produced in situ by embedding compact plastics particles in the liquid plastics material prior to application, from which plastics particles hollow microspheres are formed by supplying heat. Such a foam finish feels like foam rubber and has a rough and coarse surface, which gives rise to the disadvantage that, when a leather provided with such a foam finish is adhesively bonded to a substrate, such as, for example, a steering wheel body, the coarse structure of the foam finish proves to be troublesome on the leather surface particularly in the case of thin leathers. A further disadvantage is that the adhesive is drawn into the open cells and hardens the leather.

### SUMMARY OF THE INVENTION

It is accordingly an object of the invention to provide a leather, which overcomes the above-mentioned disadvantages of the heretofore-known devices and methods of this general type and which leather is provided on its flesh side with a foam finish by means of which not only is an attractively structured flat flesh side achieved but by means of which the mechanical and physical properties of the leather are also improved. Furthermore, it is an object of the invention to design the foam finish in such a way that, in spite of its softness, it does not feel like foam rubber, and that, when the leather provided with such a foam finish is adhesively bonded to a substrate, the adhesive does not penetrate into the foam finish, very good adhesion without roughening nevertheless being possible.

It is a further object of the invention to design the foam finish in such a way that it has the required water vapor permeability, so that, for example when the leather assembly according to the invention is used for shoes, the liquid forming in the interior thereof, such as, for example, perspiration, can pass through the foam finish and is absorbed by the leather itself but, when a pressure is applied, does not pass back to the surface of the foam finish, and this surface therefore always feels dry, which contributes considerably to the comfort of wearing in the case of shoes. As a result of the formation of the surface of the foam finish with a design through application of pressure and heat, this surface has a permanent form without, however, the water vapor permeability being substantially impaired. While in the case of a dressing arranged on the grain side, the fine fibers projecting from the leather are completely embedded in this dressing, in the foam finish according to the invention at least the long fibers projecting from the flesh side are not completely embedded but are only partly surrounded, which constitutes a substantial advantage.

With the foregoing and other objects in view there is provided, in accordance with the invention, a leather assembly, comprising:

a leather having a flesh side and a leather surface, opposite the flesh side, with a grain structure forming a visible side of the leather assembly or a dressing forming the visible side (the dressing, preferably, has a visible grain structure); and

a foam finish on the flesh side formed of a solidified plastics material containing hollow microspheres and having a surface formed with a structural design.

With the above and other objects in view there is also provided, in accordance with the invention, a method of producing such a leather assembly. The method comprises:

applying a liquid plastics dispersion or solution to a flesh side of the leather opposite the visible side, and allowing the liquid to at least partly solidify and to form an intermediate foam finish; and

applying pressure and/or heat to a surface of the intermediate foam finish to form a structural design therein and to form a foam finish containing a solidified plastics material with hollow microspheres on the flesh side opposite the visible side.

The design may be such that the surface of the foam finish is relatively flat so that it does not make a troublesome impression even in the case of thin leather on the visible side thereof. It has been found that, in the case of such a design, the tear propagation strength and the stitch tear resistance increases, particularly at those points of the hide where poor values were obtained beforehand, and the mechanical and physical properties are substantially identical at all points. Moreover, this design gives rise to the advantage that no loose-grained effect occurs on flexing, particularly of soft leathers.

The foam finish can be provided on its surface with elevations and/or indentations, for example with grooves optionally intersecting one another, with the result that, particularly when such a leather is bent around curves and edges, no loose-grained effect occurs even in the case of soft leathers. As a result of such elevations and/or indentations, which, however, are always formed so finely that they are not conspicuous on the upper side of the leather even in the case of a thin leather, it is ensured that, on adhesive bonding, the adhesive can anchor in the elevations and/or indentations and does not penetrate into the open pores.

However, the foam finish may also be provided on its surface with a leather grain embossing or with an embossing having the appearance of a textile material, with the result that the arrangement of a covering, for example of a lining, on the flesh side of the leather is no longer required. Such a covering was necessary to date, for example for use of the leather for shoes or bags, in order for the flesh side to have an attractive surface and to be smooth when such a leather was used and therefore, in the case of shoes, not to impede the putting on of a shoe. As a result of the leather formation according to the invention, the application of a fine-grained lining leather is not necessary, it also being possible to impart a different color to the dressing and to the foam finish.

A further improvement in the leather assembly according to the invention can be achieved by embedding a reinforcing material, preferably a thin plastics foam sheet or a thin textile material, in the foam finish, with the result that the strength is increased. If a thin plastics foam sheet which has open, relatively large cells is embedded in the foam finish according to the invention as reinforcing material, the cells are filled at least partly by the hollow microspheres present in the foam finish and by the solidified plastics dispersion.

In addition, the foam finish may also contain additives, for example pigments and/or fillers, preferably polysiloxane. As a result of the preferred concomitant use of nonoily polysiloxane having a high molecular weight, the foam finish loses its foam rubber-like handle and does not have a nonslip touch.

Expediently, the plastics material forming the foam finish is formed by a self-crosslinking plastics dispersion containing compact particles foamable on supply of heat. The use of such a self-crosslinking plastics dispersion has the advantage that, with heat supply which is required for the formation of the foam structure from the foamable compact particles, the crosslinking of the plastics dispersion takes place simultaneously. It is particularly advantageous if the plastics materials forming the foam finish is formed by a polybutadiene and/or polyacrylate and/or polyurethane dispersion or by mixtures thereof.

The invention furthermore relates to a process for the production of a leather, one of whose surfaces has a grain structure forming the visible side, or on one of whose surfaces a dressing forming the visible side is applied and whose flesh side is provided with a foam finish, wherein, in the method according to the invention, a plastics dispersion or solution forming the foam finish is applied to the flesh side of the leather and is allowed to at least partly solidify, whereupon a surface of the foam finish which has a design is at least partially produced by application of pressure and/or heat. This design may be of any desired form and may also have, for example, the appearance of an embossed leather grain or the appearance of a fine textile material, an improvement in the mechanical and physical properties of the leather provided with the foam finish being achieved by the design.

It is particularly advantageous if a plastics dispersion or solution forming the foam finish is first applied to the flesh side of the leather and allowed to at least partially solidify, whereupon the dressing is formed on the surface opposite this flesh side. Since the application of the plastics dispersion or solution forming the foam finish is effected before the production of the dressing, the method according to the invention achieves the advantage that the dressing cannot become soiled as a result of the application of the plastics material forming the foam finish. Moreover, the production of the dressing by means of a reverse roll coater is facilitated by the foam finish already present, since the leather side having the foam finish then rests better on the rubber-covered conveyor belt of the roll coater.

The method according to the invention furthermore permits the production of the foam finish in separate process steps by applying the plastics dispersion or solution forming the foam finish to the flesh side of the leather and allowing it to solidify, then producing the dressing on the surface opposite this flesh side, and then at least partly foaming the solidified plastics dispersion or solution by supplying heat to said dispersion or solution. In this manner, for example, the leather to whose flesh side the plastics material forming the foam finish was applied can be placed in a mold without the foaming by heat supply having as yet been effected, and heat can then be supplied, for example by means of hot air, only to those areas where the foam finish is desired. This procedure is advantageous, for example, for the production of door claddings of motor vehicles.

A further advantage of this procedure is that, on subsequent foam-filling of the mold by means of a polyurethane foam, the latter binds to the virtually closed-cell leather foam finish present on the flesh side of the leather but prevents the liquid reaction components forming the polyurethane foam from penetrating into the leather and hardening it.

The method according to the invention furthermore makes it possible first to separate out shaped parts, for example by cutting out or punching out, from the hide forming the leather, after which the plastics material forming the foam finish is applied to these parts with the result that better utilization of the hide occurs. In the case of such small shaped parts as required, for example, for steering wheel coverings, the danger of soiling of the dressing by application of the plastics dispersion or solution forming the foam finish is low so that in this case the dressing can be effected before this application of the plastics dispersion or solution.

Particularly in the production of such shaped parts provided with a foam finish, it is advantageous if the plastics material forming the dressing is first applied to the surface of the leather and then a plastics dispersion or solution forming the foam finish is applied to the flesh side of the leather and is allowed to at least partly solidify, after which both the visible side of the dressing and the surface of the foam finish are shaped by application of pressure and/or heat. In this procedure, the design, i.e. as a rule the pore structure, of the dressing as well as the design of the foam finish is shaped in a single operation.

In order to achieve the desired design of the foam finish, it is advantageous if the heat supply is effected by a hot plate or roll which acts on the plastics material forming the foam finish and preferably has a temperature of more than 135° C. and whose surface has an negative structure corresponding to the design to be produced. By means of such a hot plate or roll, not only is the foaming thus effected but also the desired design of the foam structure is produced.

Although only a single hot plate or a roll which cooperates with the side of the foam finish which is to be provided with the design is sufficient for foaming and for production of the desired design, it is in fact advantageous if the leather provided with the plastics material forming the foam finish is placed between the two plates of a platen press so that pressure is also applied simultaneously with the action of heat.

For the production of grooves forming the design, according to the invention a wire arrangement, for example a wire grating, can be arranged, preferably in a removable manner, on that side of one of the plates which cooperates with the plastics material forming the foam finish, which wire grating is expediently provided with a parting agent. The foam can thus expand between the wire, and consequently a better foam structure is achieved. After foaming, the wire, which can be used several times, is removed. However, that side of one of the plates which cooperates with the plastics material forming the foam finish can also be provided with other materials creating the elevations and/or indentations, such as, for example, a textile woven fabric or knitted fabric, an embossed paper or plastics sheets or films, which then produce the desired design. What is important here is that these materials are heat-resistant to at least 150° C. and have an antiadhesion finish. However, it is also possible to use materials to which the foam finish itself does not adhere, such as, for example, woven Teflon fabric, woven polyaramide fabric, woven carbon fabric or woven cotton fabric, which are impregnated with silicone rubber.

The foam finish may also be formed by the brief action of hot air on the plastics material. It has been found that, by such brief action of hot air emerging from a nozzle, the properties of the leather are not adversely affected but the plastics material applied to the flesh side and containing hollow microspheres expands and forms a foam finish, the volume of the leather fiber bundles projecting from the flesh side of the leather, in particular in the case of long fibers, also increasing. The leather fiber bundles projecting from the flesh side of the leather and formed by a plurality of fibers are expanded at their free ends, forming mushroom-like structures which are located close to one another and by means of which the cushioning properties are substantially improved. Moreover, the abrasion resistance of the foam finish is increased in a surprising manner.

Other features which are considered as characteristic for the invention are set forth in the appended claims.

Although the invention is illustrated and described herein as embodied in a leather assemble and method of fabricating a leather assemble, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The drawing is a magnified cross section through a leather assembly according to the invention.

### DESCRIPTION OF THE PREFERRED EMBODIMENTS

Referring now to the sole figure of the drawing in detail, there is shown a leather or leather substrate 1 which is provided, on its visible side, with a dressing 2 and, on its flesh side opposite the visible side, with a foam finish 3. The dressing 2 can be applied to the grain side of a natural leather, to one side of a split or to a nubuck leather. The dressing 2 is produced in a conventional manner, which is known to those of skill in the pertinent art. When a natural grain leather is used, the dressing 2 can also be dispensed with.

The foam finish 3 has a structural design which, in the illustrated embodiment, is formed of grooves 4. These grooves 4 may run only in one direction, parallel to one another. However, it is expedient to provide grooves which intersect one another and between which square or rectangular elevations 5 of the foam finish 3 are formed. However, the foam finish 3 can also have a different design and can possess, for example, the appearance of a fine-grained lining leather or of a textile material.

The visible side of the foam finish can also be provided with a colored finish.

In the method according to the invention, a plastics dispersion or solution forming the foam finish is applied to the flesh side of the leather and allowed at least partly to solidify, preferably before the dressing 2 is produced on the surface opposite the flesh side. Here, a plastics dispersion which contains compact particles of polyvinylidene chloride copolymer is applied to the flesh side, for example sprayed on or applied by means of a roll, and allowed to partly solidify, plastics dispersions having a softening point prior to crosslinking of less than 95° C. being particularly suitable. On formation of the hollow microspheres by application of pressure and heat, the dispersion simultaneously softens and permits a permanent shaping of the surface.

Finely divided silicates in an amount of from 0.3% by volume to 3.5% by volume, as known as dulling agents for surface coatings, are expediently mixed with the plastics dispersion forming the foam finish. A reinforcing material, preferably at thin plastics foam sheet or a thin textile material, can be embedded in the still liquid plastics dispersion.

Hollow microspheres are formed from the compact particles by supplying heat, with the result that the foam finish 3 forms. The hollow microspheres, which have a diameter of less than 50 μm, contain a gas which is at superatmospheric pressure. As a result, the cushioning properties of the foam finish are improved. The thin skin thereof consists of a thermoplastic material having a softening point of from 65° C. to 155° C. The heat required for the formation of the hollow microspheres can be supplied before or after production of the dressing 2. Preferably, however, the dressing 2 is produced after the plastics material forming the foam finish has been applied, so that soiling of the dressing by the application of this liquid plastics material is prevented.

The leather provided with the applied plastics material forming the foam finish and with a dressing can also be temporarily stored before the formation of the foam finish by supply of heat, which has the advantage that, on the one hand, the foam finish can be produced by partial heat supply only to certain, desired areas and, on the other hand, the intermediate product can be placed in a mold and, simultaneously with the formation of the foam finish, can be converted into the required design, for example door claddings of motor vehicles, so that the foam finish adapts to the respective requirements.

The heat can be supplied in various ways, for example by supplying hot air. Preferably, however, the heat is supplied by a plate or roll which is heated to a temperature of at least 135° C. and is provided, on its side cooperating with the plastics material forming the foam finish, with a structure which is a negative of the design to be produced. Such a structure can be produced, for example, by arranging a wire grating on the plate. However, other materials which have a negative structure corresponding to the desired design can also be arranged on the hot plate. Furthermore, rolls or plates which consist of silicone rubber and whose surface has a negative structure corresponding to the design to be produced can be used.

Particularly when the application of pressure is also expedient for the production of the leather assembly according to the invention, it is advantageous to place the leather between heatable plates of a platen press and thus to effect the heat supply. If the surface of both plates has a negative structure, not only the grain structure of the dressing but also the design of the foam finish can be produced in this manner in a single operation.

The plates and any wire fabric arranged on these plates or other materials producing the desired design of the foam finish are provided with an antiadhesion coating.

The completed foam finish has a hardness of less than 25 Shore A and, without a reinforcing insert, has a thickness of less than 0.35 mm and a density of less than 0.25 g/cm³ and, with the arrangement of a prefabricated plastics foam sheet or textile sheet as a reinforcing insert, a thickness of from 0.4 mm to 2.5 mm with the same density.

By means of the formation, according to the invention, of the foam finish, the tear propagation strength and stitch tear resistance are substantially improved, particularly in those areas of the leather which previously had poor values. Thus, a 1 mm thick leather having a poor tear propagation strength of 10 N has a total thickness of 1.3 mm and then a tear propagation strength of more than 30 N after production of the foam finish.

Moreover, in the case of a formation of the foam finish according to the invention, the leather has outstanding properties with respect to liquid absorption and liquid permeability. If, in a test, a leather which is provided with a foam finish according to the invention on one part of its flesh side and has no such foam finish on another part is treated on this flesh side with water, it is found that the part having the foam finish feels warm and dry and therefore pleasant within a short time after absorption of the water, even when this part is subsequently subjected to pressure, since even then the water does not return to the surface of the foam finish. On the other hand, the part not provided with a foam finish feels wet, cold and therefore unpleasant for a very long time.

I claim:

1. A leather assembly, comprising:
a leather having a flesh side and a leather surface, opposite said flesh side, with a grain structure forming a visible side of said leather assembly or a dressing forming said visible side;
a foam finish on said flesh side formed of a solidified plastics material containing hollow microspheres and having a surface formed with a structural design.

2. The leather assembly according to claim 1, wherein said dressing on said leather surface has a grain structure.

3. The leather assembly according to claim 1, wherein said surface of said foam finish is formed with at least one of elevations and indentations.

4. The leather assembly according to claim 1, wherein said surface of said foam finish is formed with grooves.

5. The leather assembly according to claim 4, wherein said grooves are intersecting grooves.

6. The leather assembly according to claim 1, wherein said surface of said foam finish is formed with a leather grain embossing.

7. The leather assembly according to claim 1, wherein said surface of said foam finish is formed with an embossing having an appearance of textile material.

8. The leather assembly according to claim 7, wherein said embossing is pressed or heat-stamped into said surface of said foam finish.

9. The leather assembly according to claim 1, which further comprises a reinforcing material embedded in said foam finish.

10. The leather assembly according to claim 9, wherein said reinforcing material is one of a thin plastics foam sheet and a thin textile material embedded in said foam finish.

11. The leather assembly according to claim 1, wherein said foam finish contains additives.

12. The leather assembly according to claim 11, wherein said foam finish containing pigments.

13. The leather assembly according to claim 11, wherein said foam finish contains polysiloxane.

14. The leather assembly according to claim 11, the foam finish contains finely divided silicates.

15. The leather assembly according to claim 14, wherein said foam finish contains from 0.3% by volume to 3.5% by volume of finely divided silicates.

16. The leather assembly according to claim 1, wherein said foam finish contains open cells between said hollow microspheres forming closed cells.

17. The leather assembly according to claim 1, wherein said foam finish has a hardness of less than 25 Shore A.

18. The leather assembly according to claim 1, wherein said foam finish has a density of less than 0.25 g/cm³.

19. The leather assembly according to claim 1, wherein said foam finish is formed by brief impact of a hot air stream on the liquid plastics material.

20. The leather assembly according to claim 1, wherein said hollow microspheres in said foam finish contain a gas under superatmospheric pressure.

21. The leather assembly according to claim 1, wherein said hollow microspheres have a diameter of less than substantially 50 μm.

22. The leather assembly according to claim 1, wherein said hollow microspheres have a skin with a softening point of from 65° C. to 155° C.

23. The leather assembly according to claim 1, wherein said plastics material forming said foam finish is formed by a self-crosslinking plastics dispersion containing compact particles foamable on heating.

24. The leather assembly according to claim 1, wherein said plastics material forming said foam finish is a dispersion of at least one polymer selected from the group consisting of polybutadiene, polyacrylate, polyurethane, and mixtures thereof.

25. The leather assembly according to claim 1, wherein said plastics material forming the foam finish contains more than 1% by weight of a high molecular weight polysiloxane dispersion.

26. The leather assembly according to claim 1, wherein said surface of said foam finish is formed with a colored finish.

27. A method of producing a leather assembly having a surface forming a visible side, which comprises:
applying a liquid plastics dispersion or solution to a flesh side of the leather opposite the visible side, and allowing the liquid to at least partly solidify and to form an intermediate foam finish;
applying at least one of pressure and heat to a surface of the intermediate foam finish to form a structural design therein and to form a foam finish containing a solidified plastics material with hollow microspheres on the flesh side opposite the visible side.

28. The method according to claim 27, which comprises first applying the liquid plastics dispersion or solution forming the foam finish to the flesh side of the leather and allowing the liquid to at least partly solidify, and subsequently producing a dressing on a surface of the leather opposite the flesh side.

29. The method according to claim 27, which comprises applying the liquid plastics dispersion or solution forming the foam finish to the flesh side of the leather and allowing the liquid to solidify, subsequently forming a dressing on a surface of the leather opposite the flesh side, and subsequently supplying heat to the dispersion or solution to at least partially foam the plastics dispersion or solution.

30. The method according to claim 27, which comprises foaming only regions of the liquid plastics dispersion by supplying heat.

31. The method according to claim 27, which comprises forming the foam finish by brief action of hot air on the plastics material.

32. The method according to claim 31, which comprises subjecting the plastics material to hot air having a temperature above 280° C.

33. The method according to claim 32, which comprises using hot air having a temperature of from 350° C. to 650° C.

34. The method according to claim 31, which comprises allowing the hot air to act on the plastics material within a period of not more than a few seconds.

35. The method according to claim 31, which comprises subjecting only certain partial regions of the plastics material to the hot air.

36. The method according to claim 31, which comprises allowing the hot air to act after complete solidification of the plastics material.

37. The method according to claim 27, which comprises first separating out shaped parts by cutting out or punching out from a hide forming the leather, and subsequently applying the plastics material forming the foam finish to the parts.

38. The method according to claim 27, which comprises first applying the plastics material forming the dressing to the surface of the leather, then applying a plastics dispersion or solution forming the foam finish to the flesh side of the leather and allowing the liquid to at least partly solidify, and subsequently shaping both the visible side of the dressing and the surface of the foam finish by application of one of pressure and heat.

39. The method according to claim 27, which comprises supplying the heat to the plastics material forming the foam finish with a bossing device selected from the group consisting of a hot plate and a roller acting thereon.

40. The method according to claim 39, wherein the embossing device has a structured surface.

41. The method according to claim 39, wherein the embossing device comprises silicone rubber and the embossing device has a surface formed with a negative structure corresponding to the structural design to be produced.

42. The method according to claim 39, which comprises setting the embossing device to a temperature of more than 135° C.

43. The method according to claim 27, which comprises placing the leather provided with the plastics material forming the foam finish between the two plates of a platen press.

44. The method according to claim 43, which comprises placing a wire configuration on a side of one of the two plates impacting the plastics material forming the foam finish.

45. The method according to claim 44, which comprises removably mounting the wire configuration on the respective plate.

46. The method according to claim 44, which comprises providing the wire configuration with a parting agent.

47. The method according to claim 42, which comprises placing materials with at least one of elevations and indentations on a side of one of the plates impacting the plastics material forming the foam finish.

48. The method according to claim 47, which comprises removably mounting the materials on the respective plate.

49. The method according to claim 47, wherein the materials consist of a fabric selected from the group consisting of woven fabric and knitted fabric.
